(19) United States
(12) Patent Application Publication
(10) Pub. No.: US 2025/0306200 A1
(43) Pub. Date: Oct. 2, 2025

(54) METHOD FOR RADAR ANGLE ESTIMATION AND RADAR SENSOR

(71) Applicant: Robert Bosch GmbH, Stuttgart (DE)

(72) Inventors: Arthur Hipke, Leonberg (DE); Lizhuo Chen, Ludwigsburg (DE)

(21) Appl. No.: 19/078,573

(22) Filed: Mar. 13, 2025

(30) Foreign Application Priority Data
Mar. 26, 2024 (DE) 10 2024 202 857.6

(51) Int. Cl. G01S 13/931; G01S 7/03

(52) U.S. Cl. CPC G01S 13/931; G01S 7/03

(57) ABSTRACT

A method for angle estimation using transmitted signals and signals received after reflection of a radar sensor. The radar sensor includes a multiple input multiple output (MIMO)-capable antenna array having a plurality of transmission antennas and a plurality of reception antennas. A MIMO dual-target cross-path model is used for the angle estimation of a locating angle of a radar target, which also models reflections of transmitted and/or received signals on a reflective surface. A first angle of two transmission and reception angles of the cross-path model is estimated using a one-dimensional angle estimation model and the estimated first angle is used for the angle estimation of the second angle of the two transmission and reception angles using the cross-path model.

### CROSS REFERENCE

The present application claims the benefit under 35 U.S.C. § 119 of German Patent Application No. DE 10 2024 202 857.6 filed on Mar. 26, 2024, which is expressly incorporated herein by reference in its entirety.

### FIELD

The present invention relates to a method for angle estimation by means of transmitted signals and signals of a radar sensor that are received after reflection, which sensor comprises a multiple input multiple output (MIMO)-capable antenna array having a plurality of transmission antennas and a plurality of reception antennas, wherein a MIMO cross-path model is used for the angle estimation of a locating angle of a radar target, which also models reflections of transmitted and/or received signals on a reflective surface.

The present invention also relates to a radar sensor, a computer program and a machine-readable storage medium.

### BACKGROUND INFORMATION

In driver assistance systems of motor vehicles, in addition to the spacing and relative velocity of located objects, the azimuth angle and the elevation angle are also important for monitoring the environment, since this angle information is used to carry out a lane assignment and to make a statement about the relevance of the object (can be driven over/driven against/driven under).

Azimuth and elevation angles of the objects to be located can be ascertained from amplitude and/or phase differences of transmission and/or reception antennas of an antenna array of a radar sensor. In order to improve the accuracy and separation capability of the angle estimation of such a radar sensor, the MIMO principle is often used for radar sensors. In contrast to classic single input multiple output (SIMO) radar sensors, which use only one transmission antenna and a plurality of reception antennas, a plurality of transmission antennas and a plurality of reception antennas are used. During angle estimation, the reception signals are compared to a previously measured, angle-dependent antenna radiation pattern. In the case that there is only one object in a (d, v) cell (spacing/velocity cell), the estimated locating angle is the position of the best match between the reception signal and the antenna radiation pattern.

U.S. Pat. No. 8,436,763 B2 describes a MIMO radar sensor that uses the MIMO principle with code division multiplexing and two transmission antennas in order to improve azimuth angle estimation. The two transmission antennas are arranged at the left and right edges of the overall array in order to achieve the largest possible virtual aperture.

In the case of a multipath propagation of radar signals of a radar sensor 10 shown by way of example in FIG. 1, four different paths 14a, 14b to 20a, 20b of signal propagation occur due to reflections on a radar mirror 12, such as, e.g., a crash barrier or a road surface: In the first path 14a, 14b (direct-direct), the signal propagates without reflection directly from the radar sensor 10 to an object 24 and back to the radar sensor 10. In the second path 16a, 16b (direct-reflected), the signal propagates directly from the radar sensor 10 to the object 24 but is reflected on the way back to the radar sensor 10. In the third propagation path 18a, 18b (reflected-direct), the signal is reflected on the way to the object 24 and runs on the way back without reflection directly to the radar sensor 10. In the fourth propagation path 20a, 20b (reflected-reflected), the signal is reflected on the way to the object 24 and the radar echo is reflected again on the way back at the same surface 12.

The second and third paths 16, 16b, 18a, 18b are also known as cross-paths, since the direction of the transmitted signal (direction-of-departure DOD) and the direction of the received signal (direction-of-arrival DOA) are different from one another. A first transmission and reception angle θ1 is assigned to the direct path 14a, 14b. For example, the first transmission and reception angle θ1 can be defined between a surface normal 25 of the radar sensor 10 and the first path 14a, 14b. A surface of the radar sensor 10 can be the area on which the antennas of the radar sensor 10 are located. An angle of 0° (boresight) can then mean that the propagation direction of the received or transmitted electromagnetic wave is perpendicular to the surface defined by the antenna positions. A second transmission and reception angle θ2 is assigned to the reflected path 16b, 18a, 20a, 20b. For example, the second transmission and reception angle θ2 can be defined between the surface normal 25 and the reflected path 16b, 18a, 20a, 20b. Signal models that depict this multipath propagation are called (four-path) cross-path models. A straight-line signal propagation extension of the reflection path starting from the radar sensor 10 suggests the presence of a non-real mirror object 26.

If multipath propagation is ignored in the signal model, a MIMO angle estimation produces incorrect estimates with errors of a plurality of angular degrees. This can then lead to undesirable system behavior, such as side track disturbances or target object losses. Multipath propagation also means that the virtual array model cannot be used in MIMO beamforming (beamforming of both the transmission and reception beams). In F. Engels, P. Heidenreich, M. Wintermantel, L. Stacker, M. Al Kadi and A. M. Zoubir, “Automotive Radars Signal Processing: Research Directions and Practical Challenges,” in IEEE Journal of Selected Topics in Signal Processing, doi: 10.1109/JSTSP.2021.3063666, beamforming with separate arrays for the transmission angle (direction of departure, DOD) and reception angle (direction of arrival, DOA) is presented as a remedy.

Furthermore, Germany Patent Application No. DE 10 2021 212 376 A1 describes a method for a MIMO radar sensor in which the complete four-path cross-path model of multipath signal propagation is applied. The method allows accurate angle estimation for a plurality of target objects.

### SUMMARY

It is an object of the present invention to provide measures that make possible an accurate and reliable angle estimation of the locating angle of a radar object with reduced computational effort and low computing capacity of a radar sensor in the case of multipath propagation.

The object may be achieved by a method, a radar sensor, a computer program and a machine-readable storage medium having certain features of the present invention. Preferred example embodiments of the present invention are disclosed herein.

According to a first aspect of the present invention, a method is provided for angle estimation by means of transmitted signals and signals of a radar sensor that are received after reflection, which sensor includes a MIMO-capable antenna array having a plurality of transmission antennas and a plurality of reception antennas. According to an example embodiment of the present invention, for the angle estimation of a locating angle of a radar target, a MIMO dual-target cross-path model is used, which also models reflections of transmitted and/or received signals on a reflective surface. A first angle of two transmission and reception angles of the cross-path model is estimated using a one-dimensional angle estimation model, and the estimated first angle is used for the angle estimation of the second angle of the two transmission and reception angles using the cross-path model.

In the method according to the present invention, the computationally and thus cost-intensive angle estimation of the locating angle (in azimuth and/or elevation) of a radar target can be simplified when using a (four-path) MIMO dual-target cross-path model in such a way that the evaluation of a MIMO cross-path model that takes into account the multipath propagation of the signal, which corresponds to a two-dimensional optimization problem, can be reduced to a one-dimensional optimization problem. In the dual-target model, the radar object can be treated as one object target and the mirror object as a second object target. As a result, the accuracy of the dual-target object cross-path model can be utilized while simultaneously increasing the velocity of angle estimation. Compared to a classic SIMO and/or MISO angle estimation, the method can make possible a reduction in the outlier probabilities and an increase in the precision of the estimation.

According to an example embodiment of the present invention, for this purpose, an initial one-dimensional angle estimation of one of the transmission and reception angles of the cross-path model can be carried out first in a one-dimensional angle estimation model. In this one-dimensional model, it can be assumed that only one target object is present. This step can therefore involve very little computational effort and still allow a sufficiently accurate estimation of the first angle.

The actual angle estimation can then be effected by fixing the estimated first angle in the cross-path model for two target objects and determining the second transmission and reception angle. As a result, in this second step, the two-dimensional optimization problem can be reduced to an effectively one-dimensional optimization problem, which can also reduce the computational effort of the angle estimation of the locating angle of the radar object.

For example, the angle that can be assigned to the direct path of multipath propagation can be estimated first and then used for estimating the second angle that can be assigned to the reflected path of multipath propagation. The first angle can in particular be defined between a surface normal of the radar sensor and the direct path. The second angle can be defined between the surface normal and the reflected path.

The first angle can correspond to the searched for locating angle of the radar target.

In one example embodiment of the present invention, the one-dimensional angle estimation model can be based on a dual-target cross-path model for a single input multiple output (SIMO) and/or a multiple input single output (MISO) mode of the radar sensor (30), and the model can use only one column vector in a control matrix assigned to the model. The radar object can thus be located in a SIMO, MISO or combined SIMO-MISO mode of the radar sensor. In SIMO mode, a signal can be transmitted from a single transmission antenna, and the signal received by the plurality of reception antennas can be evaluated in a plurality of reception channels in order to calculate an angular spectrum in at least one dimension based on the phase and amplitude relationships using the MIMO cross-path model. In MISO mode, on the other hand, signals can be sent in time, frequency or code division multiplex from a plurality of transmission antennas, and for the evaluation of the associated radar echoes only the signals in a single reception channel, i.e., one antenna, can be evaluated. In this way, again based on a cross-path model, a further angular spectrum is obtained, which, however, differs in its information content from the angular spectrum obtained in SIMO mode. The information available in the two spectra can also be combined in the combined SIMO-MISO mode. Thus, in this embodiment, based on a dual-target cross-path model for a SIMO and/or MISO mode, it can be assumed that the object corresponding to the second angle is not present in order to obtain a one-dimensional angle estimation for the first angle. In this way, a similarly precise and reliable angle estimation of the first angle can be achieved as with the MIMO method, but the computational effort in this step can be significantly reduced due to the restriction to a single transmission antenna in SIMO mode and due to the restriction to a single reception antenna in MISO mode.

In particular, according to an example embodiment of the present invention, a measurement for locating the radar object can be carried out only once by means of a plurality of or all transmission antennas and a plurality of or all reception antennas of the MIMO array and only signals of the transmission antenna(s) and reception antenna(s) assigned to the SIMO or MISO mode can be evaluated for SIMO or MISO or combined SIMO and MISO evaluation of the signal. Subsequently, the signals of the plurality of or all transmission antennas and the plurality of or all reception antennas can be evaluated to estimate the second angle.

Alternatively, according to an example embodiment of the present invention, the radar sensor can first be operated in SIMO or MISO or both modes and thereafter a MIMO measurement can be carried out to estimate the second angle.

It is also possible that the one-dimensional angle estimation model is based on a MIMO model for only one object target, i.e., a single-target virtual array model can be used for angle estimation. This can also reduce the computational effort.

In one example embodiment of the present invention, a global maximum can be searched for in a spectrum of the deterministic maximum likelihood (DML) estimation function of the one-dimensional angle estimation model for the angle estimation of the first angle, and the found global maximum can be used for the angle estimation of the second angle in a DML estimation function of the cross-path model in order to find a further global maximum, which corresponds to the second angle, in a spectrum of the DML estimation function of the cross-path model. As a result, a sufficiently accurate estimation of all transmission and reception angles can be easily made possible.

In one example embodiment of the present invention, for the angle estimation of the second angle, the estimation (in the cross-path model) can be repeated in an angle range around the found global maximum (from the one-dimensional angle estimation model) in order to find the second angle as the global maximum. As a result, the robustness of the method against estimation errors of the first angle can be reduced, since the second angle can be re-estimated for slightly deviating first angles. The angle pair searched for can then correspond to the estimated first angle and the second angle estimated for the deviating first angle, or to the deviating first angle and the second angle estimated for the deviating first angle.

In one example embodiment of the present invention, for the angle estimation of the first and second angles, a two-dimensional search for a global maximum of the DML estimation function of the cross-path model can be carried out in an angle range around the found further global maximum of the estimation function of the cross-path model, and the global maximum found thereby can then correspond to the first angle and the second angle. As a result, the robustness of the method against estimation errors can also be reduced by allowing all transmission and reception angles to be estimated once again around the first found maximum of the cross-path model.

In one example embodiment of the present invention, separate DML estimation functions can be calculated for a spectrum obtained in SIMO mode and a spectrum obtained in MISO mode, and then a sum spectrum can be formed by arithmetic averaging of the two DML estimation functions, and a global maximum of the estimation function can be searched for in the sum spectrum that corresponds to the locating angle of one object. This type of signal evaluation or actual sensor operation with corresponding signal evaluation can make possible a Joint MISO-SIMO DoA-DoD Estimation (JoSSIE) mode of the radar sensor. In a pure JoSSIE signal evaluation, only the corresponding signals are taken into account. The radar sensor can be operated in SIMO and MISO mode (in any order) one after the other for a JoSSIE measurement. This non-coherent spectrum addition can make possible the formation of a suitable one-dimensional sum spectrum in order to ascertain the first angle.

According to a second aspect of the present invention, a radar sensor for a motor vehicle is provided, which comprises a transmission and reception unit having a MIMO-capable antenna array and an evaluation unit, in which a method according to the first aspect of the present invention is implemented.

According to a third aspect of the present invention, a computer program is provided which is configured to carry out steps of a method according to the first aspect of the present invention if executed by a processor, in particular of an electronic evaluation unit of the radar sensor according to the second aspect. The computer program can comprise instructions and form a control unit code comprising an algorithm for carrying out the method of the present invention.

According to a fourth aspect of the present invention, a machine-readable storage medium is provided on which a computer program according to a third aspect of the present invention is stored. The machine-readable storage medium can be designed, for example, as an external memory, as an internal memory, as a hard disk or as a USB storage device.

### BRIEF DESCRIPTION OF THE DRAWINGS

Preferred embodiments of the present invention are explained in more detail below with reference to the figures.

FIG. 1 is a diagram for illustrating a scenario with multipath propagation.

FIG. 2 shows a radar sensor according to an exemplary embodiment of the present invention.

FIG. 3 shows a MIMO-capable antenna array having transmission antennas and reception antennas, according to an example embodiment of the present invention.

FIG. 4 is a block diagram for a method according to one exemplary embodiment of the present invention.

FIG. 5 shows angle-dependent spectra of DML estimation functions obtained under the same environmental conditions in SIMO mode, MISO mode, JoSSIE mode and MIMO mode of the radar sensor shown in FIG. 2 using a cross-path model having a target object.

### DETAILED DESCRIPTION OF EXAMPLE EMBODIMENTS

FIG. 2 shows a radar sensor 30 according to an exemplary embodiment. It is part of a driver assistance system for a motor vehicle and comprises a transmission and reception unit 32 having a two-part MIMO-capable antenna array 34 and an evaluation unit 36 for monitoring the environment. The evaluation unit 36 can, for example, comprise a processor and a memory of a conventional computer. A computer program can be stored in the memory, which is configured to control the radar sensor 30 so that it carries out the method described below.

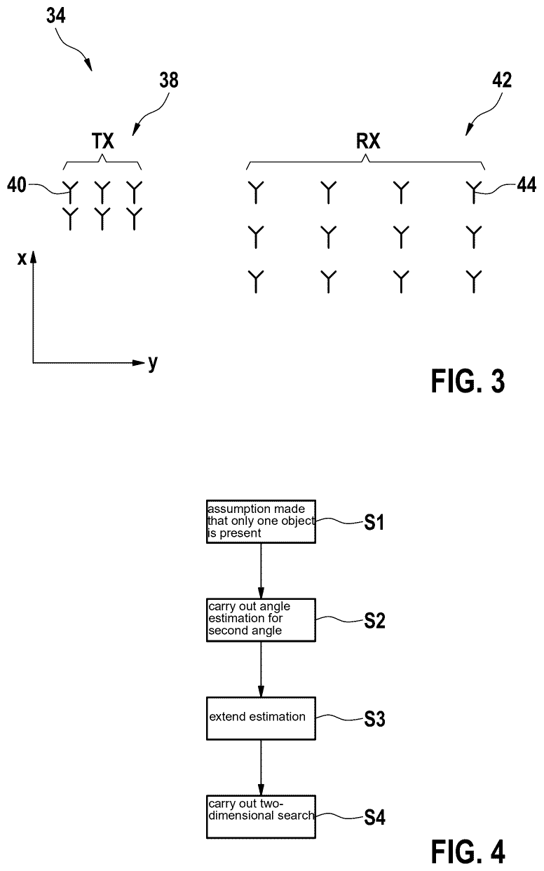

The two-part MIMO-capable antenna array 34 shown in FIG. 3 comprises a transmission array 38 having transmission antennas 40 and a reception array 42 having reception antennas 44. In the example shown, both arrays 38, 42 are two-dimensional, so that in principle MIMO angle measurements are possible both in azimuth and in elevation for monitoring the environment. In the reception array 42, the reception antennas 44 are arranged at equal spacings in an angular resolution direction x, e.g., in the direction of the azimuth. The spacings between the individual reception antennas 44 are so large that a large aperture and a correspondingly high angular resolution can be achieved with just a few antennas 44. However, the spacings from antenna 44 to antenna 44 are greater than half the wavelength of the radar radiation emitted by the radar sensor 30, and so the Nyquist uniqueness criterion is not met. In the example shown here, the reception antennas 44 are also arranged at equal spacings in elevation (in the angular resolution direction y), and in this direction as well, the antenna spacings are so large that a non-unique undersampling is effected. In this example, the transmission antennas 40 of the transmission array 38 are also arranged at equal spacings in azimuth (x-direction) and elevation (y-direction), but the spacings are chosen so that a unique angle measurement is possible. However, the aperture is significantly smaller than that of the reception array 42, such that the angular resolution is lower. The equidistant arrangement of the antenna elements (in azimuth and elevation) facilitates the evaluation of the data, since it makes possible, for example, the use of a fast Fourier transform (FFT) for calculating a two-dimensional angular spectrum.

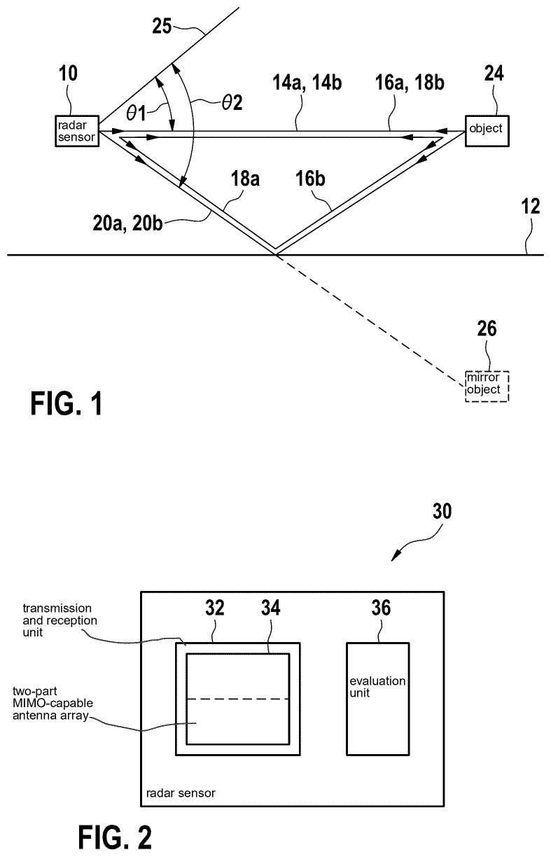

The evaluation unit 36 of the radar sensor 30 controls the radar sensor 30 in such a manner that the method shown in FIG. 4 is carried out during operation of the radar sensor 30. The method is described by way of example for a real object to be recognized in the environment of the radar sensor 30 using a MIMO four-path cross-path model for dual-target objects, namely the real object and the mirror object (see FIG. 1).

The transmission array 38, controlled by the evaluation unit 36, transmits radar signals, which are described by complex amplitudes and phases, by means of the transmission antennas 40, and the reception array 42 receives the radar signals by means of its reception antennas 44 and transmits corresponding signals in the form of measured complex amplitudes and phases to the evaluation unit 36. In the evaluation unit 36, a two-dimensional spectrum in the dimensions of spacing d and relative velocity v is first calculated in a conventional manner by Fourier transformation. Using this spectrum, the individual objects can then be identified and their spacings and relative velocities can be determined. From this information, the locating angle of the radar target (object 24 in FIG. 1) can then be determined by means of the control matrix, which models the angle-dependent signal component.

For the angle estimation of the locating angle of the radar object, the MIMO cross-path model having the four paths 14a, 14b to 20a, 20b for two object targets as shown in FIG. 1 is used. For simplicity, it is assumed that only the angle estimation in azimuth is considered, in which only the first row of the transmission antennas 40 in the transmission array 38 and only the first row of the reception antennas 44 in the reception array 42 are used.

If one assumes that only the direct-direct path 14a, 14b is present for easier understanding of the cross-path model explained below, the following is determined in the MIMO case for a virtual array model having only one object target (the real object 24), which can also be referred to as a MIMO single-target model, the vector x of the received signals for all transmission (tx) reception (rx) combinations, taking into account the locating angle θ of the real object assigned to the direct path 14a, 14b (for example, the angle θ between a surface normal 25 of the radar sensor 30 and the direct path 14a, 14b is given), the complex channel coefficient s and the channel noise n to x=a(θ)*s+n. Here (with the Kronecker product ⊗), a(θ) is defined as a(θ)=atx(θ)⊗arx(θ) or as a(θ)=a′tx(θ)⊗a′rx(θ) with a′tx(θ)=[atx, n(θ)/atx1(θ)]_{n=1, . . . Ntx}, a′rx(θ)=atx,1(θ)*arx(θ).

If one assumes that, in addition, the reflected-reflected path 20a, 20b is present, the following applies in the MIMO case for a virtual array model having 2 object targets (the real object 24 and the mirror object 26, MIMO dual-target model): x=A(θ1, θ2)*s+n with A(θ1, θ2)=[a′tx(θ1)⊗a′rx(θ1) a′tx(θ2)⊗a′rx(θ2)]. The angles θ1 and θ2 are illustrated in FIG. 1 and designate the transmission and reception angles assigned to the direct path 14a, 14b and the reflected path 20a, 20b, respectively. For example, 01 is given between the surface normal 25 of the radar sensor 30 and the direct path 14a, 14b and thus corresponds to the locating angle of the real object 24. The angle θ2 can, for example, be given between the surface normal 25 and the reflected path 20a, 20b and correspond to the angle assigned to the mirror object 26.

In the complete four-path cross-path model having two object targets (the real object 24 and the mirror object 26), the vector x of the received signals is determined as x=A(θ1, θ2)*s+n. Here, A designates the control matrix and is given by:
A(θ1, θ2)=[a′tx(θ1)⊗a′rx(θ1) a′tx(θ2)⊗a′rx(θ2) a′tx(θ2) ⊗a′rx(θ1) a′tx(θ1)⊗a′rx(θ2)]

θ1 and θ2 are illustrated in FIG. 1 and explained in more detail above. Due to the reciprocity of the cross-paths 16, 18, the last two terms can be combined into a single path. However, the computational effort for the angle estimation of θ1, θ2 by means of the DML estimation function

$${q}^{2} ( θ1 , θ2 ) = {\underline{x}}^{H} * {P}_{A} ( θ1 , θ2 ) * \underline{x} with {P}_{A} ( θ1 , θ2 ) = {A ( {A}^{H} A )}^{- 1} {A}^{H}$$

where θ1 and θ2 are estimated by maximizing q²(θ1, θ2) is high. The control matrix A cannot be separated into angular dimensions θ1, θ2. Therefore, it is not possible to define them by means of vectors that depend only on θ1 or θ2. The resulting correlation of the columns of the control matrix means that a one-dimensional angle estimation for accelerating the two-dimensional angle estimation by means of a MIMO dual-target cross-path model may be subject to errors, but at the same time can reduce the computational effort. Such a one-dimensional angle estimation model can, for example, be the MIMO single-target model shown above, but its angle estimation will most likely be subject to errors. A corresponding one-dimensional angle estimation, which uses a dual-target cross-path model for the SIMO, MISO or JoSSIE mode and assumes that only one object target is present, exhibits this limitation to a much lesser extent.

Therefore, in a first method step S1 of the method, the assumption is made that, instead of two objects (real object and mirror object), only one object (real object or mirror object) is present and the radar sensor 30 is operated in MIMO mode for signal measurement. The evaluation of the signal in step S1 is effected under the assumption that a SIMO, MISO or JoSSIE mode is present. Therefore, only the antenna signals associated with the mode are taken into account, as explained below. In SIMO mode, the control matrix of the dual-target cross-path model simplifies to A(θ1, θ2)=[a′rx(θ1) a′rx(θ2)] and in MISO mode to A(θ1, θ2)=[a′tx(θ1) a′tx(θ2)]. Evaluating the single-target DML estimation function q²(θ)=IA(θ)^{H}xI², where the vector associated with θ2 is omitted from the control matrix A, results in the angle estimation for the angle θ1 as θ1t=argmax q²(θ).

In SIMO mode, only signals that are transmitted by a single transmission antenna 40 and received by the plurality of reception antennas 44 are evaluated. In MISO mode, only signals transmitted by the plurality of transmission antennas 40 and received by only a single reception antenna 44 are evaluated. In JoSSIE mode, separate DML estimation functions are calculated for a spectrum obtained in SIMO mode and a spectrum obtained in MISO mode, then a sum spectrum is formed by arithmetic averaging of the two DML estimation functions, and a global maximum of the estimation function is searched for in the sum spectrum, which global maximum corresponds to the locating angle θ1t of the first object.

In a second method step S2, an angle estimation for the second angle θ2 is thereafter carried out, in which the estimated angle θ1t is used for the angle estimation of the angle θ2 using the complete MIMO dual-target four-path cross-path model. In other words, the DML estimation function is evaluated for the complete control matrix A by fixing θ1 to θ1t, and a global maximum is searched for in the angle spectrum of the estimation function q². Thus, θ2 is given as θ2=argmax q² (θ1t, θ2).

In order to increase the robustness of the method, it is possible, in an optional method step S3, which is carried out after step S2, to extend the estimation by a range around the angle θ1t, which was estimated in the first step S1, i.e., to carry out the estimation of θ2 once again in this limited angle range around θ1 for the various slightly deviating θ1 values, which are designated as θ1′ (e.g., integer values from the interval [θ1-3 degrees; θ1+3 degrees]) and to search for a global maximum in the estimation of θ2 for the θ1′ values. If a better estimation θ2′ is available for the second angle, the angle pair searched for can be defined as θ1t, θ2′ or as θ1t′, θ2′.

Following method step S2 or S3, an optional step S4 can be carried out in which a two-dimensional search is carried out for a global maximum of the DML estimation function in an angular range around the global maximum found in step S2, which has corresponded to θ2. The global maximum resulting from this search then corresponds to the angle pair θ1, θ2. As a result, the robustness of the method is also increased.

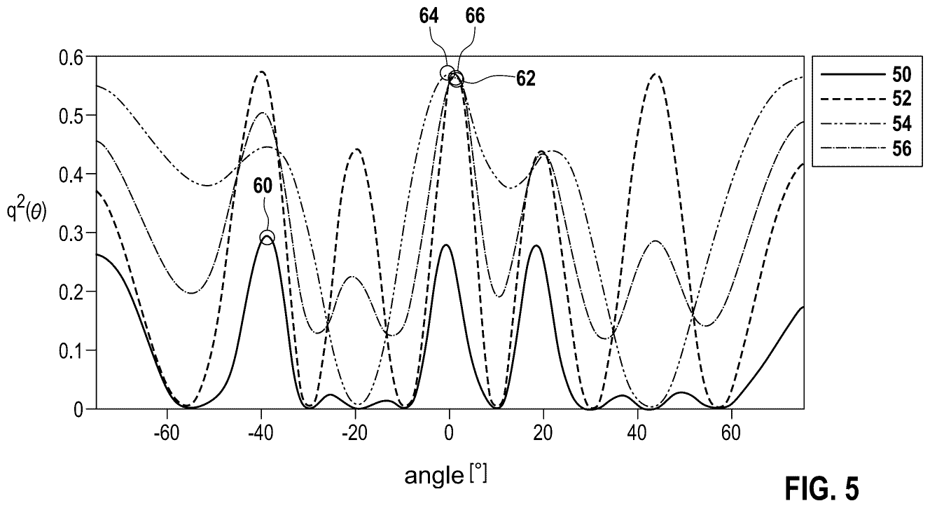

FIG. 5 shows the DML estimation function 50 to 56 obtained in step S1 for a MIMO mode, SIMO mode, MISO mode and a JoSSIE mode of the radar sensor 30. The respective maxima 60 to 66 are marked by circle symbols. The initial scenario (ground truth) is given by θ1=0°, θ2=20°, where the real object 24 and the mirror object 26 are to be located. In ground truth, all four paths of multipath propagation show the same amplitude. The spacings of the reception channels defined by the position of the reception antennas are given by [0 1.5 3 4.5] λ and the spacings of the three transmission channels defined by the transmission antennas are [0 1 2]λ. Here, λ designates the wavelength of the emitted and received radar signals. It can be seen that the global maximum 60 of the MIMO spectrum 50 does not sufficiently match the ground-truth positions. In the case of spectra 52 to 56 in SIMO, MISO and JoSSIE modes, the matching with the ground truth assumption is sufficiently accurate, such that the found maxima 62 to 66 correspond sufficiently accurately to the locating angle θ1 of one object.

What is claimed is:

1. A method for angle estimation using transmitted signals and signals of a radar sensor that are received after reflection, the sensor including a multiple input multiple output (MIMO)-capable antenna array having a plurality of transmission antennas and a plurality of reception antennas, wherein a MIMO dual-target cross-path model is used for the angle estimation of a locating angle of a radar target, which also models reflections of transmitted and/or received signals on a reflective surface, the method comprising the following steps:
estimating a first angle of two transmission and reception angles of the cross-path model using a one-dimensional angle estimation model; and
using the estimated first angle for an angle estimation of the second angle of the two transmission and reception angles using the cross-path model.

2. The method according to claim 1, wherein the one-dimensional angle estimation model is based on a dual-target cross-path model for a single input multiple output (SIMO) and/or a multiple input single output (MISO) mode of the radar sensor, in which only one column vector is used in a control matrix assigned to the one-dimensional angle estimation model.

3. The method according to claim 1, wherein, for the angle estimation of the first angle, a global maximum is searched for and found in a spectrum of a deterministic maximum likelihood (DML) estimation function of the one-dimensional angle estimation model, and the found global maximum is used for the angle estimation of the second angle in a DML estimation function of the cross-path model in order to find a further global maximum, which corresponds to the second angle, in a spectrum of the DML estimation function of the cross-path model.

4. The method according to claim 3, wherein, for the angle estimation of the second angle, the estimation is repeated in an angle range around the found global maximum in order to find the second angle as the global maximum.

5. The method according to claim 3, wherein, for the angle estimation of the first and second angles, a two-dimensional search is carried out for a global maximum of the DML estimation function of the cross-path model in an angle range around the further global maximum found in the cross-path model, which corresponds to the first angle and the second angle.

6. The method according to claim 2, wherein separate DML estimation functions are calculated for a spectrum obtained in SIMO mode and a spectrum obtained in MISO mode, and then a sum spectrum is formed by arithmetic averaging of the DML estimation function and the separate DML estimation function, and a global maximum of the estimation function is searched for in the sum spectrum that corresponds to the first angle.

7. A radar sensor for a motor vehicle, the radar sensor comprising:
a transmission and reception unit having a MIMO-capable antenna array; and
an evaluation unit configured for angle estimation using transmitted signals and signals of a radar sensor that are received after reflection, wherein a MIMO dual-target cross-path model is used for the angle estimation of a locating angle of a radar target, which also models reflections of transmitted and/or received signals on a reflective surface, the evaluation unit configured to:
estimate a first angle of two transmission and reception angles of the cross-path model using a one-dimensional angle estimation model; and
use the estimated first angle for an angle estimation of the second angle of the two transmission and reception angles using the cross-path model.

8. A non-transitory machine-readable storage medium on which is stored a computer program for angle estimation using transmitted signals and signals of a radar sensor that are received after reflection, the sensor including a multiple input multiple output (MIMO)-capable antenna array having a plurality of transmission antennas and a plurality of reception antennas, wherein a MIMO dual-target cross-path model is used for the angle estimation of a locating angle of a radar target, which also models reflections of transmitted and/or received signals on a reflective surface, the computer program, when executed by a processor, causing the processor to perform the following steps:
estimating a first angle of two transmission and reception angles of the cross-path model using a one-dimensional angle estimation model; and
using the estimated first angle for an angle estimation of the second angle of the two transmission and reception angles using the cross-path model.
